(19) United States
(12) Patent Application Publication
(10) Pub. No.: US 2009/0135822 A1
(43) Pub. Date: May 28, 2009

(54) METHOD AND APPARATUS FOR CONTROLLING PACKET FORWARDING

(75) Inventors: Jun Hirano, Kanagawa (JP); Chan Wah Ng, Singapore (SG); Pek Yew Tan, Singapore (SG); Tien-Ming Benjamin Koh, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 11/915,418

(22) PCT Filed: May 31, 2006
(86) PCT No.: PCT/JP2006/311361

§ 371 Date: Nov. 26, 2007

(30) Foreign Application Priority Data
May 31, 2005 (JP) 2005-160183

(51) Int. Cl. H04L 12/56

(52) U.S. Cl. 370/392

(57) ABSTRACT

A technology is disclosed for reducing the number of encapsulations required when MAP forwards a packet to a mobile node which is layered within mobile networks, with mobile networks nested and multiple mobile routers chained behind MAP (Mobility Anchor Point). MAP 120 manages the binding information between RCoA and LCoA for each of lower-level nodes and grasps the prefixes of each of lower-level mobile routers, for example, the prefix of mobile network 104 of MR 140 or the prefix of mobile network 106 of MR 142. For example, MAP 120 informs MR 140 of the prefix of the mobile network 106 and the binding information between RCoA and LCoA. In this way, MR 140 can grasp a next forwarding destination of the packet transmitted from MAP 120 to MN 150, and the packet can be reached at MN 150 unless the packet is encapsulated multiple times.

### TECHNICAL FIELD

The present invention relates to a packet forwarding control method and apparatus in packet-switched data communications networks such as an IP (Internet Protocol) network. More particularly, the present invention relates to a packet forwarding control method and apparatus to forward packets sent and received by nodes which use Mobile IP and HMIP (Hierarchical Mobile IP).

### BACKGROUND ART

Many devices today communicate with each other using the IP network. In order to provide mobility support to mobile devices, the Internet Engineering Task Force (IETF) has developed the “Mobility Support in IPv6” (see the following Non-patent Document 1). In Mobile IP, each mobile node has a permanent home domain. When the mobile node is attached to its home network, it is assigned a primary global address known as a home address (HoA).

When the mobile node is away, i.e. attached to some other foreign networks, it is usually assigned a temporary global address known as a care-of address (CoA). The idea of mobility support is such that the mobile node can be reached at the home-address even when it is attached to other foreign networks.

This is done in the Non-patent Document 1 with an introduction of an entity at the home network known as a home agent (HA). Mobile nodes register their care-of addresses with the home agents using Binding Update (BU) messages. This allows the home agent to create a binding between the home address and care-of address of the mobile node. The home agent is responsible to intercept messages that are addressed to the mobile node's home address, and forward the packet to the mobile node's care-of address using packet encapsulation (i.e. putting one packet as the payload of a new packet, also known as packet tunneling).

Although Mobile IP enables mobility support in the otherwise stationary addressing architecture of IP infrastructure, there exist a few deficiencies. One such deficiency is the need to send Binding Updates to home agents or correspondent nodes whenever the mobile device changes its point of attachment to the Internet. For a node with high mobility, such as a mobile device on a vehicle, the frequency at which the mobile node needs to send Binding Updates becomes prohibitively high.

For this reason, the IETF is currently developing a Hierarchical Mobile IPv6 Mobility Management Protocol (HMIP, see the following Non-patent Document 2). The concept in HMIP is very similar to that contained in the following Patent Document 1. Here, an entity known as a Mobility Anchor Point (MAP) is defined, which handles a relatively large segment of an access network, allowing any mobile nodes roaming within the access network segment managed by a MAP to use the same care-of address. The trick here is for the mobile node to obtain a local care-of address (LCoA) for its current point of attachment, and register this LCoA with the MAP. Upon registration, a regional care-of-address (RCoA) will be assigned to the mobile node, which the mobile node uses to send Binding Updates to its home agent. Thus, any packets sent to the home address of the mobile node will be encapsulated by its home agent, and forwarded to the RCoA of the mobile node. The MAP will intercept this packet, and tunnel it to the LCoA of the mobile node.

This greatly reduces the number of Binding Updates the mobile node needs to send to its home agent or correspondent nodes. As long as the mobile node moves within the access network segment managed by the same MAP, the mobile node will only change its LCoA while its RCoA remains unchanged. Thus, the mobile node only needs to notify the MAP of its LCoA, and need not send Binding Updates to its home agent or correspondent nodes. Only when the mobile node moves out of the access network segment managed by the original MAP, then a new RCoA needs to be assigned and the mobile node sends Binding Updates to its home agent or correspondent nodes.

The following Patent Document 2 further enhances HMIP by providing a mechanism for mobile nodes or correspondent nodes to detect failures of the MAP. When this happens, Patent Document 2 provides for a back-off method for the mobile node to fall back to use its LCoA as the care-of address while locating a new MAP.

With the ever-increasing proliferation of wireless devices, it is foreseeable that a new class of mobility technology will emerge: network mobility, or NEMO, where a whole network of nodes changes its point of attachment in entirety. Extending the concept of mobility support for individual hosts to mobility support for a network of nodes, the objective of a network in motion solution is to provide a mechanism where nodes in a mobile network can be reached by their primary global addresses, no matter where on the Internet the mobile network is attached to.

The IETF is currently developing solution for network mobility as disclosed in the following Non-patent Document 2. Here, it is specified that the mobile router when sending BU to its home agent, will specify the network prefix which the nodes in the mobile network are using. These are specified using special options known as Network Prefix Options to be inserted into the BU. These allow the home agent to build a prefix-based routing table so that the home agent will forward any packets sent to destinations with these prefixes to the care-of address of the mobile router. This idea of using the bi-directional tunnel between the mobile router and its home agent is also described in the following Patent Document 3.

Although this simple mechanism of bi-directional tunnel allows for network mobility support, a nesting of mobile networks will result in a long-winded path from a correspondent node to a node in a nested mobile network. This is because with each level of nesting (i.e. a mobile router attaching itself to a mobile network managed by another mobile router), a packet sent to a node in the innermost mobile network needs to go through an additional tunnel. Because the tunnel end-points are the home agents of mobile routers, these can be distributed all over the Internet, causing the packet to go through a long-winded path.

To solve this problem, another solution proposed in the following Non-Patent Document 4 involves the use of a Reverse Routing Header to avoid having too many levels of encapsulation when mobile network get nested (i.e. a mobile network attaching itself to another mobile network). Here, the downstream mobile router sets up a Reverse Routing Header in its tunnel packet to its home agent. As upstream mobile routers intercept this tunnel packet on its way, each upstream mobile router does not encapsulate this packet into another IP-in-IP tunnel. Instead, the upstream mobile router copies the source address in the packet to the Reverse Routing Header, and puts its own care-of-address as the source address. In this way, when the home agent of the first mobile router receives the packet, it can determine the chain of mobile routers that is in the path between the first mobile router and itself. Subsequently when the home agent wishes to forward another intercepted packet for the first mobile router, it can include an extended Type 2 Routing Header so that the packet is directly sent to the first mobile router via other upstream mobile routers.

Nesting is not the only problem with network mobility support. As with Mobile IP, network mobility also faces the same issue of frequent Binding Updates if the network is moving rapidly. It is unclear how HMIP can be integrated to the network mobility support solution. One obvious approach is for a mobile router to register its LCoA with the MAP, obtain an RCoA from the MAP, and use this as the care-of address to send Binding Updates to its home agent. This, however, may arise to a long-winded routing when one considers nesting of mobile networks.

To illustrate this, consider the network deployment scenario depicted in FIG. 1. Here, the mobile router MR 142 is attached to the mobile network 104, which is managed by another mobile router MR 140. Mobile router MR 140 is attached to access router AR 130 that belongs to the access network 102 managed by the MAP 120. The mobile router MR 142 manages the mobile network 106 (in which, we show one mobile network node MN 150). Home agent HA 110 is the home agent for mobile router MR 140, home agent HA 112 is the home agent for mobile router 142, home agent 114 is the home agent for mobile node MN 150 and the network 100 is, for example, the global internet. All mobile routers MR 140, 142 and mobile node MN 150 use HMIP by registering with MAP 120.

Suppose CN 160 now sends a packet to MN 150. FIG. 2 depicts the path the packet will take to reach MN 150. First, the packet addressed to the home-address of MN 150 from CN 160 will take the path 210 to the home agent HA 114 of MN 150. HA 114 will then forward the packet to the RCoA of MN 150. This will result in the path 212 to the MAP 120. MAP 120 intercepts the packet, and tunnels it to the LCoA of MN 150. However, since the LCoA of MN 150 is configured from the prefix of mobile network 106, it will take the path 214 to the home agent HA 112 of the mobile router MR 142. HA 112 then forwards the packet to the RCoA of MR 142, taking the path 216 back to MAP 120.

MAP 120 tunnels this packet to the LCoA of MR 142. Again, since LCoA of MR 142 is configured from the prefix of the mobile network 104, it will take the path 218 to the home agent HA 110 of the mobile router MR 140. HA 110 then forwards the packet to the RCoA of MR 140, taking the path 220 to MAP 120. MAP 120 tunnels the packet to the LCoA of MR 140 with the path 222. MR 140 decapsulates the packet, and forwards it to MR 142. Finally, MR 142 decapsulates the packet, and forwards it to MN 150.

From the above description, one can see the problem of simply combining HMIP with network mobility support. A packet addressed to a mobile node in a nested mobile network will take a long-winded path, possibly passing through the MAP multiple times. Not only is this a waste of network resources, it also greatly increases the packet latency. This can be unacceptable for real-time applications, such as voice-over-IP or other multimedia sessions that are getting more and more popular.

It might be plausible for one to extend the concept of sending prefix information with Binding Updates in network mobility support to HMIP. Alternatively, the MAP can delegate prefix to mobile routers when they register with it. This delegated prefix can then be used in the mobile network managed by the mobile router so that mobile nodes attached to the mobile network can configure their LCoAs from the delegated prefix.

In both cases, the MAP will be aware of the prefix handled by a mobile router when the mobile router registers with the MAP. When the MAP receives a packet addressed to the RCoA of a mobile node, it can check the prefix table and realize that the mobile node has an LCoA within the prefix of the mobile network, and instead of tunneling the packet straight to the LCoA of the mobile node, it tunnels the packet to the mobile router. Doing so will cause the routing path shown in FIG. 2 to be greatly shortened with the extra paths 214, 216, 218 and 220 removed.

[Patent Document 1]: Malki, K., Soliman, H., “Hierarchical Mobility Management For Wireless Networks”, US Patent Application No 2001/0046223A1, November 2001.

[Patent Document 2]: Venkitaraman, N., “Method and Apparatus for Robust Local Mobility Management in a Mobile Network”, US Patent Application No 2003/0185196A1, October 2003.

[Patent Document 3]: Leung, K. K., “Mobile IP mobile router”, U.S. Pat. No. 6,636,498, October 2003.

[Non-patent Document 1]: Johnson, D. B., Perkins, C. E., and Arkko, J., “Mobility Support in IPv6”, Internet Engineering Task Force (IETF) Request For Comments (RFC) 3775, June 2004.

[Non-patent Document 2]: Soliman, H., et. al., “Hierarchical Mobile IPv6 Mobility Management (HMIPv6)”, IETF Internet Draft: draft-ietf-mipshop-hmipv6-04.txt, Work-in-progress, December 2004.

[Non-patent Document 3]: Devarapalli, V., et. al., “NEMO Basic Support Protocol”, IETF RFC 3963, January 2005.

[Non-patent Document 4]: Thubert, P., and Molteni, M., “IPv6 Reverse Routing Header and Its Application to Mobile Networks”, Internet Draft: draft-thubert-nemo-reverse-routing-header-04.txt, Work In Progress, February 2004.

Although the use of prefix information can eliminate the long-winded routing problem, it does not solve all problems. The MAP will still need to encapsulate packets to the mobile routers. To illustrate this problem, consider the previous example depicted in FIG. 2. Although MAP 120 uses prefix information to remove the unnecessary paths 214, 216, 218 and 220, it still needs to tunnel the packet first to the LCoA of MN 150, then to the LCoA of MR 142, and finally to the LCoA of MR 140. On top of the original encapsulation by HA 114, the packet is encapsulated four times.

This is illustrated in FIG. 3. Here, we see that the path 310 from CN 160 to MN 150 needs to go through the tunnel 320 from HA 114 to MN 150, tunnel 330 from MAP 120 to MN 150, tunnel 340 from MAP 120 to MR 142, and tunnel 350 from MAP 120 to MR 140.

So, there is a problem that each additional level of encapsulation adds a significant header overhead to the packet, and thus will incur a substantial processing delay at each encapsulating/decapsulating node. Furthermore, there is another problem that the chances of packet fragmentation en route also increase.

### DISCLOSURE OF THE INVENTION

In light of the foregoing Issues, it is thus an object of the present invention to reduce the number of encapsulations required when MAP forwards a packet to a mobile node which is layered within mobile networks, with mobile networks nested and multiple mobile routers chained behind MAP.

In order to achieve the foregoing object, the present invention provides a method of controlling packet forwarding in a communication system, the communication system including a mobility anchor point which manages a hierarchical network, a mobile router which comprises a mobile network and a mobile node which is attached to the mobile network, the mobility anchor point storing address binding information on a binding between a local address for identifying location of a communication node within a network of the mobility anchor point and a global address used by the correspondent node to communicate with an outside of the network, the mobile node using an address configured based on a prefix advertised within the mobile network to communicate, wherein the mobile node is attached under the mobility anchor point's control, and wherein the mobility anchor point stores the address binding information on both the mobile router and the mobile node, the method comprising a step in which the mobility anchor point informs a mobile router on route to the mobile node about the address binding information of the mobile node and the prefix of the mobile network.

Moreover, in addition to the above-mentioned, the method of controlling packet forwarding of the present invention comprises:

a prefix delegating step in which the mobility anchor point delegates a prefix to the mobile router, the delegated prefix being available for the prefix of the mobile network; and

a step in which the mobility anchor point informs a mobile router on route to the mobile router about the delegated prefix.

Moreover, in addition to the above-mentioned, the method of controlling packet forwarding of the present invention comprises an address/prefix storing step in which the mobile router on route between the mobile node and the mobility anchor point stores the address binding information of the mobile node and the prefix of the mobile network if the mobile node or the mobile network resides at a lower level than the mobile router, the address binding information and the prefix being disseminated by the mobility anchor point.

Moreover, in addition to the above-mentioned, the method of controlling packet forwarding of the present invention comprises:

a first packet forwarding step in which the mobility anchor point, when forwarding the packet to the mobile node, tunnels the packet to the local address of a mobile router which resides at a top level on route to the mobile node;

a second packet forwarding step in which the mobile router on route between the mobile node and the mobility anchor point, when receiving the packet, determines a next hop mobile router by referring to the address binding information of the mobile node and the prefix of the mobile network which the mobile router stores, changes a destination address of the packet to the local address of the determined mobile router and then forwards the packet.

Moreover, in addition to the above-mentioned, in the method of controlling packet forwarding of the present invention, when the packet is forwarded, an address of the mobile node is placed in the packet in order to indicate that a final receiver of the packet is the mobile node.

Moreover, in addition to the above-mentioned, the method of controlling packet forwarding of the present invention comprises:

a packet sending step in which the mobile node, when forwarding the packet toward the mobility anchor point, tunnels the packet to the local address of a mobile router which resides at a bottom level on route to the mobility anchor point; and

a packet forwarding step in which the mobile router on route between the mobile node and the mobility anchor point, when receiving the packet, determines a next hop mobile router by referring to the address binding information of the mobile node and the prefix of the mobile network which the mobile router stores, changes a destination address of the packet to the local address of the determined mobile router and then forwards the packet.

In order to achieve the foregoing object, the present invention provides an apparatus for controlling packet forwarding arranged in a mobility anchor point which manages a hierarchical network, comprising:

a registration table storing means for storing address binding information on a binding between a local address for identifying location of a communication node within a network of the mobility anchor point and a global address used by the correspondent node to communicate with an outside of the network;

a prefix storing means for storing a prefix of a mobile network behind a mobile router whose address binding information is registered at the registration table storing means; and

an address informing means for informing a mobile router on route to the mobile node about the address binding information registered in the registration table storing means and the prefix of the mobile network.

In order to achieve the foregoing object, the present invention provides an apparatus for controlling packet forwarding arranged in a mobile router which comprises a mobile network, comprising:

an address/prefix receiving means for, from a mobility anchor point which manages address binding information on a binding between a local address for identifying location of a communication node within a network of the mobility anchor point and a global address used by the correspondent node to communicate with an outside of the network, receiving the address binding information of the mobile node which resides at a lower level than itself and the prefix of the mobile network of the mobile router which resides at a lower level than itself; and

an address/prefix storing means for storing the address binding information and the prefix received by the address/prefix receiving means.

The present invention comprising the foregoing construction has the advantage of reducing the number of encapsulations required when MAP forwards a packet to a mobile node which is layered within mobile networks, with mobile networks nested and multiple mobile routers chained behind MAP.

### BRIEF DESCRIPTION OF THE DRAWINGS

FIG. 1 is a diagram showing an example of common network arrangement in the prior art and the embodiments of the present invention;

FIG. 2 is a diagram showing routes of packets sent from CN to MN in FIG. 1 when utilizing the prior art;

FIG. 3 is a schematic diagram of multiple levels of packet encapsulation via routes shown in FIG. 2;

FIG. 4 is a diagram showing an example of architecture of MAP in the embodiments of the present invention;

FIG. 5 is a diagram showing an example of architecture of MR in the embodiments of the present invention;

FIG. 6 is a diagram showing an example of the Registration Table or the Prefix Table which MAP stores in the embodiments of the present invention;

FIG. 7 is a diagram showing an example of a registration response message format in the embodiments of the present invention;

FIG. 8 is a flowchart showing an example of an algorithm used when a registration unit of MAP processes a registration message in the embodiments of the present invention;

FIG. 9 is a flowchart showing an example of an algorithm used when a routing unit of MAP determines a next hop destination in the embodiments of the present invention;

FIG. 10 is a flowchart showing an example of an algorithm used when a routing unit of MAP processes a packet addressed to RCoA of the mobile node in the embodiments of the present invention;

FIG. 11 is a flowchart showing an example of an algorithm used when a routing unit of MAP processes a packet received from the upstream network in the embodiments of the present invention;

FIG. 12 is a flowchart showing an example of an algorithm used when a routing unit of MAP processes a packet received from the downstream network in the embodiments of the present invention; and

FIG. 13 is sequence chart showing an example of message exchange in the network architecture shown in FIG. 1.

### BEST MODE FOR CARRYING OUT THE INVENTION

Description will be given below on the preferred aspects of the present invention referring to the drawings.

The present invention describes a method used by a mobility anchor point (MAP) to eliminate the need for multiple levels of tunnel encapsulations related to mobile nodes nested within mobile networks. The basic method is for the MAP to disseminate prefix information of mobile networks managed by registered downstream mobile routers to upstream mobile routers, so that when upstream mobile routers are forwarding packets between mobile nodes nested within their mobile networks and the MAP, the upstream mobile routers can simply change the source or destination address of the packets to eliminate unnecessary tunneling or to overcome ingress filtering.

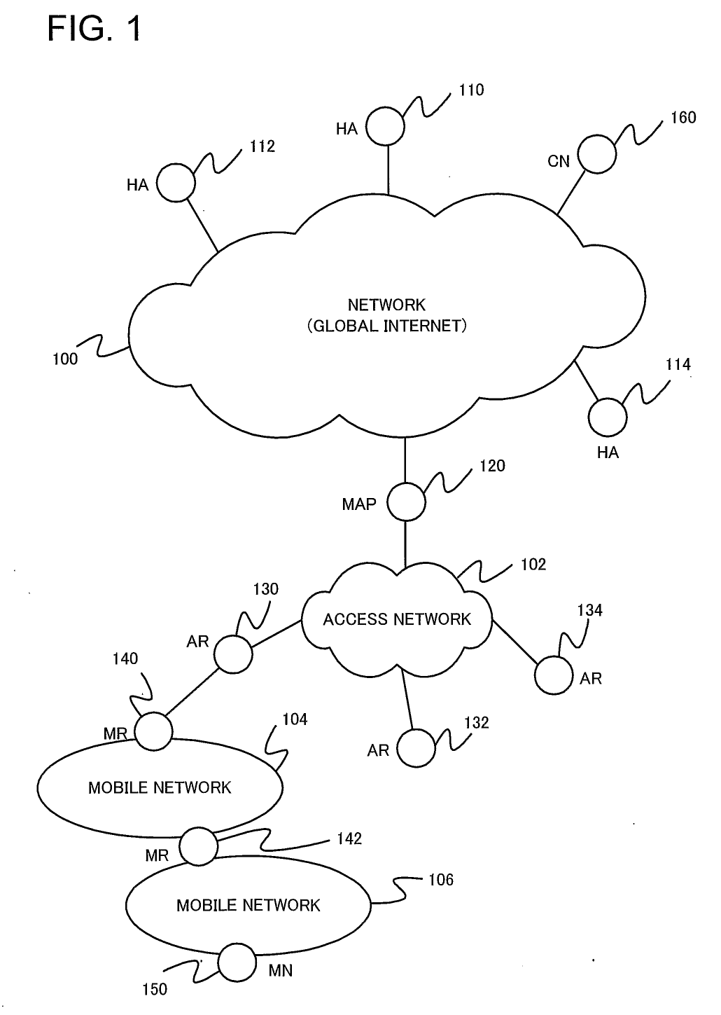

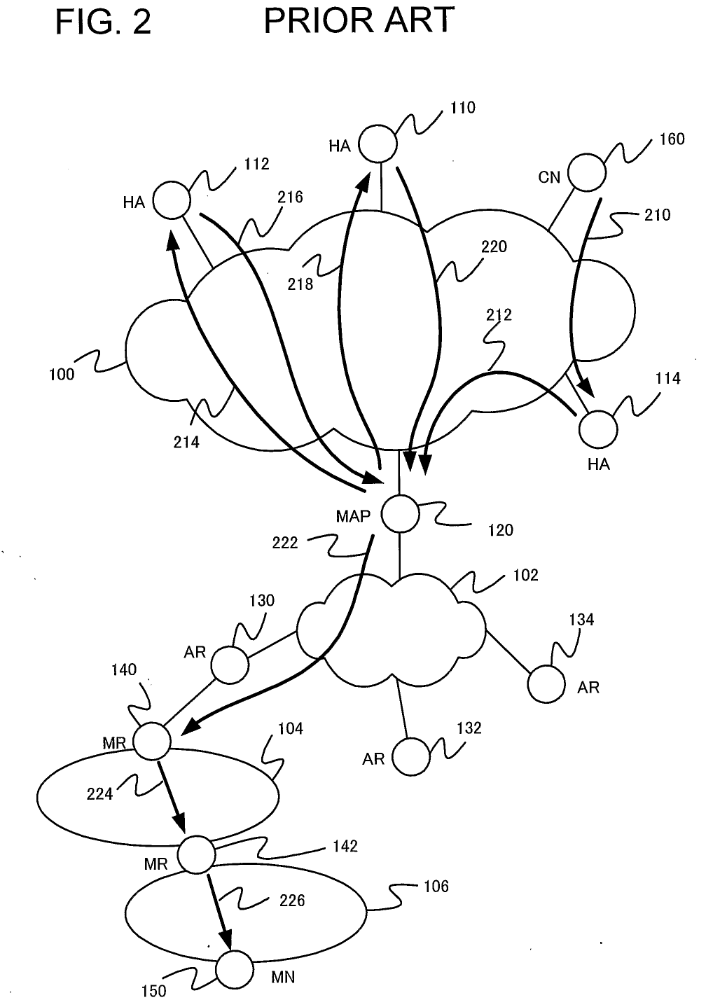

Descriptions follow hereinafter, for instance, using network architecture shown in FIG. 1 as an example. In FIG. 1, when MAP 120 receives a packet addressed to the RCoA of mobile node MN 150, it encapsulates the packet to be tunneled to LCoA of MN 150. However, in the source address of the outer packet, MAP 150 places the LCoA of mobile router MR 140 instead of LCoA of MN 150. When MR 140 receives this packet, based on the prefix information of mobile network 106 disseminated by MAP 120 previously, MR 140 changes the destination address to the LCoA of mobile router MR 142. When MR 142 receives this packet, it again changes the destination address of the packet to LCoA of MN 150.

In this way, there is no need for MAP 120 to tunnel the packet thrice: once to LCoA of MN 150, once to LCoA of MR 142, and once to LCoA of MR 140. Only one tunnel is sufficient. Similarly, when MN 150 has a packet to be forwarded by MAP 120, it tunnels this packet to MAP 120. When MR 142 receives this tunnel packet, instead of further encapsulating this packet, it simply changes the source address of the tunnel packet to its own LCoA. Again, when MR 140 receives this tunnel packet, it changes the source address to its own LCoA. This way, there is no need for each of MN 150, MR 142, and MR 140 to encapsulate the packet individually resulting in three encapsulations. One encapsulation by MN 150 is sufficient.

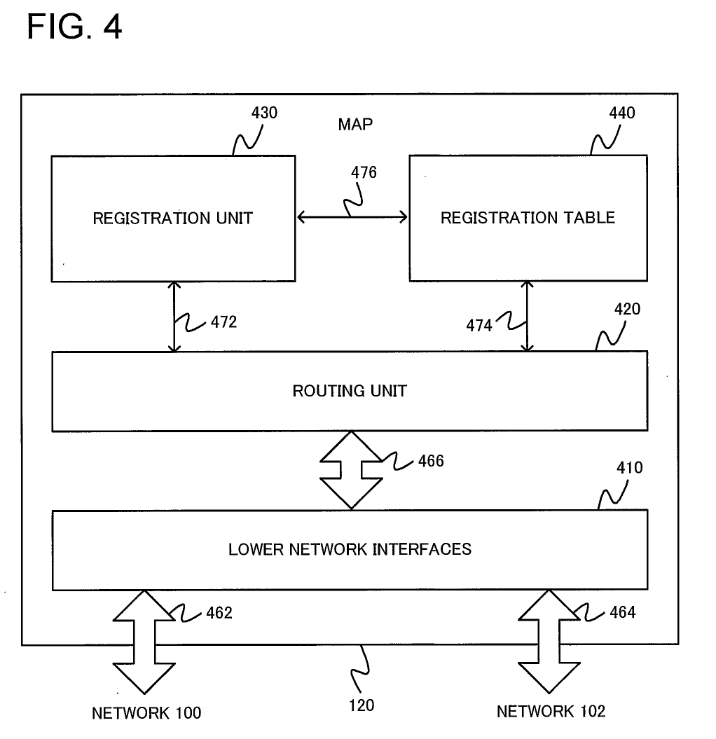

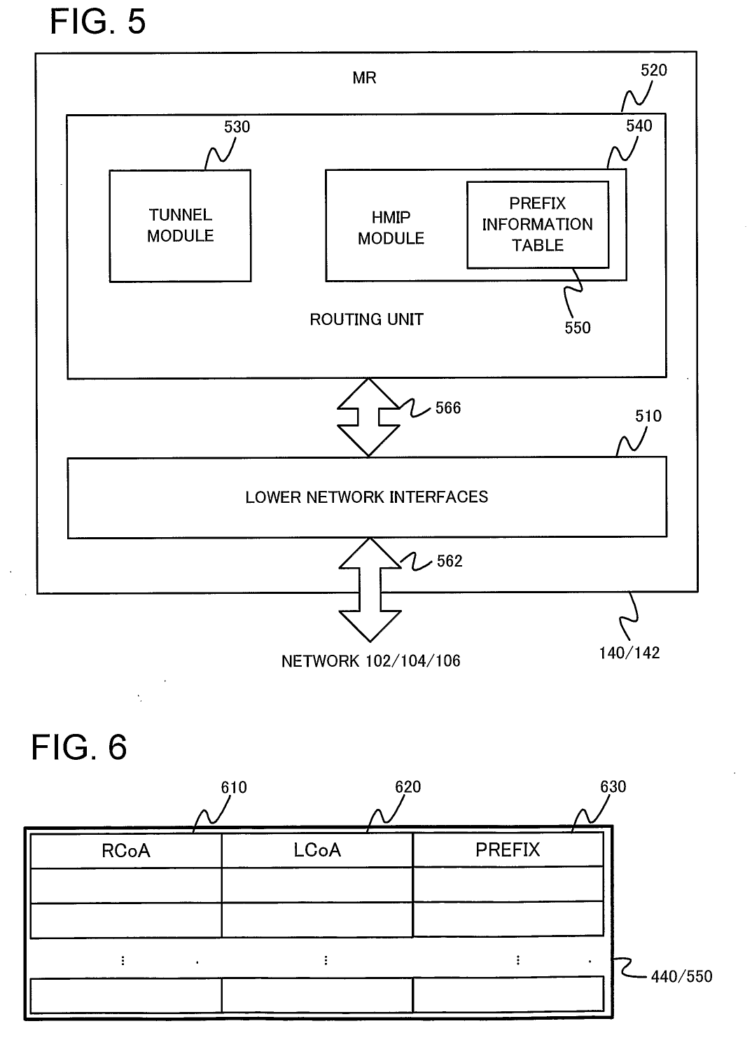

To achieve the aforementioned operation, the present invention provides a functional architecture for the MAP and the mobile router, as shown in FIG. 4 and FIG. 5 respectively. The functional architecture of MAP 120 as shown in FIG. 4 comprises a Lower Network Interface 410, a Routing Unit 420, a Registration Unit 430 and a Registration Table 440.

The Lower Network Interface 410 is a functional block that represents all networking hardware, software and protocols that are necessary to allow the MAP 120 to communicate with other nodes on a packet-switched data communications network. For instance, under the International Standards Organization's (ISO) Open System Interconnect (OSI) 7-layers model, the Lower Network Interface 510 will encompass the Physical and Data Link Layers. Packets received from the network 100 or 102 will go through the packet path 462 or 464 to be processed by the Lower Network Interface 410. If the packet is intended for the MAP 120 by the physical address, it will be passed to the Routing Unit 420 via the packet path 466.

The Routing Unit 420 handles all processing with respect to routing in the internetworking layer. Under the OSI model, it encompassed all functionalities of Network Layer. The Routing Unit 420 is responsible for forwarding packets to their next hops based on their final destinations. To do its work correctly, the Routing Unit 420 will need to consult the Registration Table 440 via the signal path 474. This includes checking for the mapping of RCoA to LCoA and verifying prefixes. In addition, if the received packet is actually a registration message from a mobile node, the message will be passed to the Registration Unit 430 for further processing via the signal path 472.

The Registration Unit 430 is responsible for maintaining registrations of mobile nodes. It will create the mapping of RCoA to LCoA of a mobile node when the mobile node makes a registration and store the mapping into the Registration Table 440 via the signal path 476. In addition, when the mobile node is a mobile router, the Registration Unit 430 will also maintain the prefix information of the mobile network associated with the mobile router in the Registration Table 440.

The Registration Table 440 stores the information of registrations from mobile nodes. This includes the mapping from RCoA to LCoA and, in the case where the registered node is a mobile router, the prefix information of the mobile network managed by the mobile router as well. Most of such registrations would usually have validity period (commonly known as lifetime) associated with, so the Registration Table 440 would also store such timing information in order to keep the information stored up-to-date. Details of the Registration Table 440 will be disclosed later.

The functional architecture of the mobile router MR 140 or MR 142, as shown in FIG. 5, comprises a Lower Network Interface 510 and a Routing Unit 520. No application functions are shown since the present invention is only interested in the routing function provided by mobile routers MR 140 or MR 142. It should be obvious to any person skilled in the art that the applications functionality can be easily added without any impact on the present invention.

The Lower Network Interface 510 is a functional block that represents all networking hardware, software and protocols that are necessary to allow MR 140 or MR 142 to communicate with other nodes on a packet-switched data communications network. For instance, under the International Standards Organization's (ISO) Open System Interconnect (OSI) 7-layers model, the Lower Network Interface 510 will encompass the Physical and Data Link Layers. Packets received from a network 100, an access network 102, a mobile network 104 or 106 will go through the packet path 562 to be processed by the Lower Network Interface 510. If the packet is intended for MR 140 or MR 142 by the physical address, it will be passed to the Routing Unit 520 via the packet path 566.

The Routing Unit 520 handles all processing with respect to routing in the internetworking layer. Under the OSI model, it encompassed all functionalities of Network Layer. The Routing Unit 520 is responsible for forwarding packets to their next hops based on their final destinations. To do its work correctly, within Routing Unit 520 two additional modules are provided: Tunnel Module 530 and HMIP Module 540.

The Tunnel Module 530 handles necessary encapsulation of packets to the home agent of the mobile router, and necessary decapsulation of packets from the home agent of the mobile router. The HMIP Module 540 handles registrations to the MAP, and maintenance of prefix information disseminated by the MAP. The prefix information disseminated by the MAP are stored in the Prefix Information Table 550, which includes the RCoA and LCoA of downstream mobile nodes, and, in the case of a downstream mobile router, the prefix information of the mobile network managed by the mobile router as well. Most of such information would usually have validity period (commonly known as lifetime) associated with, so the Prefix Information Table 550 would also store such timing information in order to keep the information stored up-to-date.

FIG. 6 shows the contents stored in the Registration Table 440 and Prefix Information Table 550. These two tables are essentially identical in terms of the contents stored. Each row in the table corresponds to an entry containing information about a mobile node.

The RCoA field 610 contains the regional care-of address of the mobile node and the LCoA field 620 contains local care-of address of the mobile node. If the mobile node is a mobile router, the prefix field 630 contains the prefix information of the mobile network manage by the mobile router. If the mobile node is not a mobile router, the prefix field 630 is left empty, indicating that there is no prefix associated with the mobile node. Note that the prefix field 630 includes the complete prefix information: i.e. the bit pattern of the prefix and also the number of significant bits in the prefix (more commonly known as prefix length).

Note that prefix associated with the mobile network may be configured in various approaches. Unless explicitly stated, the present invention does not make any assumptions on the prefix associated with the mobile network. One approach in configuring the prefix is that the prefix is the one delegated to the mobile router by its home network. This prefix is made known to the MAP when the mobile router registers with the MAP, via the use of Mobile Network Prefix options as defined in Non-Patent Document 3. Another approach is that this prefix is delegated to the mobile router by the MAP during registration. This means that, when the mobile router registers its RCoA and LCoA to the MAP, it also inserts a special option to request for prefix delegation. The MAP then replies in the registration response with a delegated prefix for the mobile router's use. Alternatively, the MAP may implement Prefix Delegation functionality of the Dynamic Host Configuration Protocol (DHCP) to assign prefixes to mobile routers.

Having described the functional architecture of the MAP and mobile routers, we now focus on how the prefix information of a mobile router can be disseminated by the MAP. Prefix Information are usually disseminated when MAP is responding to a registration made by a mobile node. In HMIP, the registration request sent by a mobile node is in the form of a Binding Update message, and the registration response sent by MAP to the mobile node is in the form of a Binding Acknowledgement message. To disseminate the prefix information, MAP an insert a special option into the packet header of the registration response message. This special option is hereafter referred to as Registration/Prefix Information, or simply, RP-Info.

Placing the prefix information into the registration response has the advantage of limiting the dissemination of prefix information only to mobile routers that are at the upstream of the mobile node. For instance, consider the deployment scenario depicted in FIG. 1. After mobile router MR 142 has made a successful registration to MAP 120, MAP 120 will respond with a registration response message. In this message, the prefix information associated with MR 142 will be inserted. Since the registration response message must be routed through MR 140, MR 140 is able to retrieve the inserted prefix information from the registration response message.

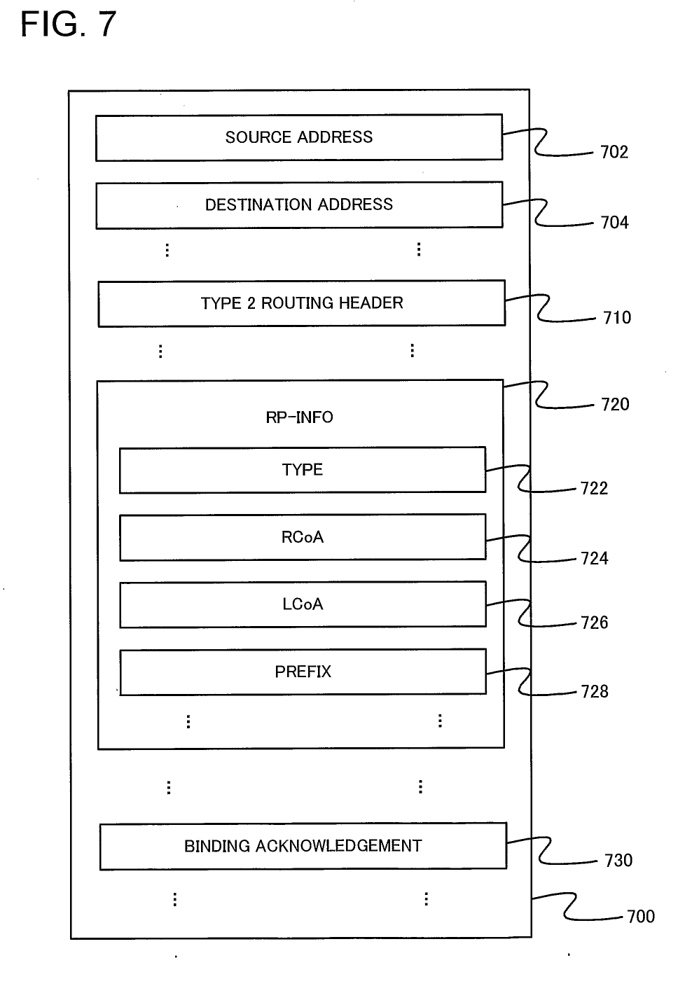

FIG. 7 shows the contents of the registration response message 700. The source address field 702 contains the address of the sender (i.e. the MAP 120). The destination address field 704 contains the address of the first intermediate destination. The type 2 routing header 710 contains the intended final recipient. The RP-Info 720 is inserted in the header of the packet 700. The type field 722 indicates this option as a RP-Info option. The RCoA field 724 contains the RCoA of the mobile node and LCoA field 726 contains the LCoA of the mobile node. If the mobile node is a mobile router, the prefix field 728 contains prefix information of the mobile network managed by the mobile router.

As mentioned earlier, the registration response message 700 is a Binding Acknowledgement message. The header 730 contains details of the binding acknowledgement. Note that not all contents of the packet are shown in FIG. 7. A person skilled in the art will recognize some other essential fields are not relevant to the operation of the present invention and are thus omitted.

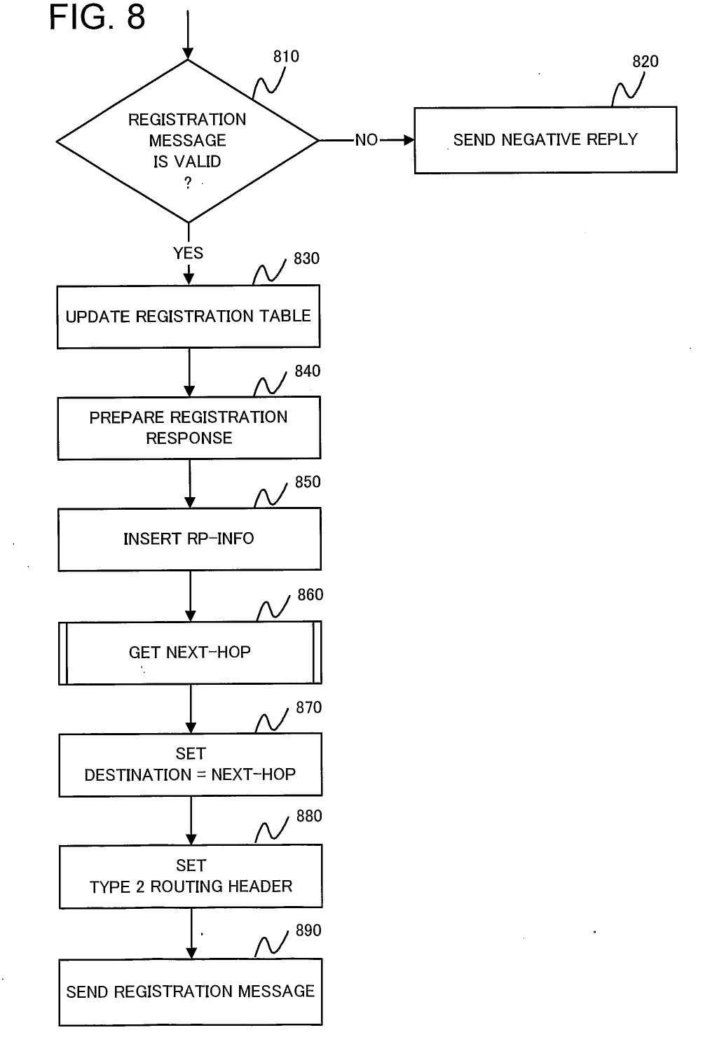

To disseminate the prefix information using RP-Info option inserted to registration response, the Registration Unit 430 of MAP 120 will follow the flowchart shown in FIG. 8 when handling received registration messages from mobile nodes.

In FIG. 8, the received registration message is first checked to see if the message is valid in step 810. This may include, but not limited to, checking the validity of the RCoA. If the registration message is invalid, a negative response is sent back to the mobile node as shown in step 820.

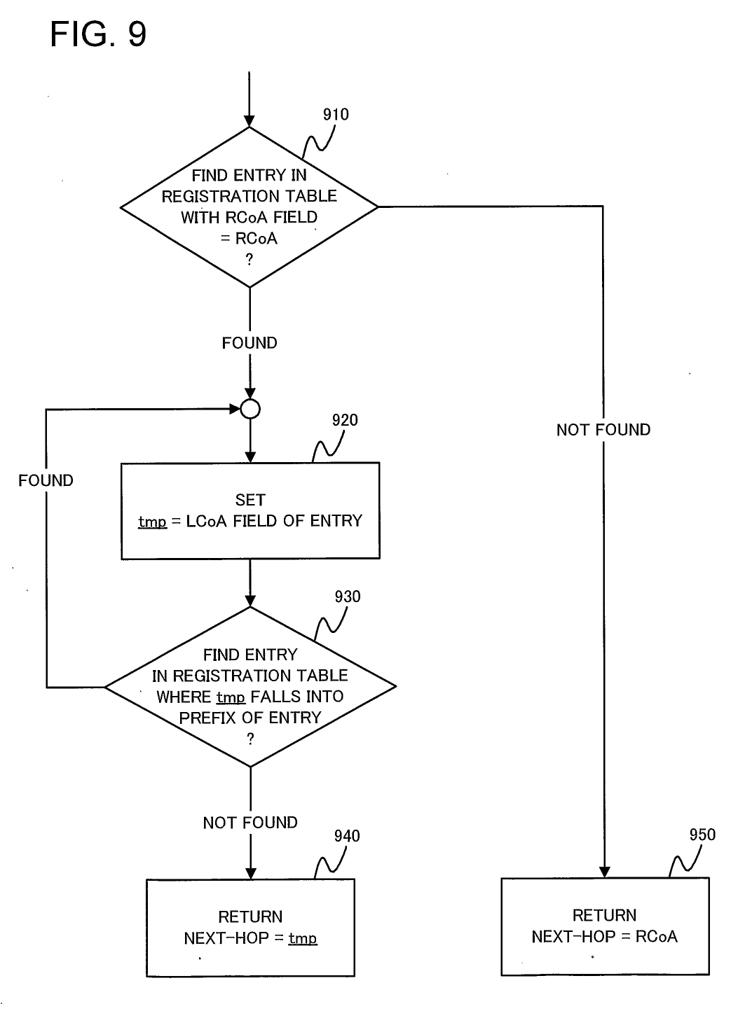

On the other hand, if the registration message is valid, the series of steps from 830 through 890 will be carried out. In step 830, the Registration Table 440 is first updated with the information conveyed in the registration message. In step 840, a registration response is prepared, containing the appropriate response for acknowledging a successful registration. An RP-Info option containing information on the LCoA and RCoA of the mobile node (and prefix information, if applicable) is inserted to the packet header of the registration message, as shown in step 850. In step 860, the next-hop destination given the RCoA of the mobile node is obtained. The algorithm to obtain this next-hop destination is shown in FIG. 9 and detailed later.

After obtaining this next-hop destination, in step 870, the destination field of the registration message is then set to this next-hop destination. To ensure that the registration message is received by the mobile node, a type 2 routing header is also inserted to the registration message containing the RCoA of mobile node in step 880. Finally, in step 890, the registration message is sent out.

FIG. 9 shows the algorithm used by the Routing Unit 420 of MAP 120 to determine the next intermediate destination to send a packet to a registered mobile node given the RCoA of the mobile node.

In FIG. 9, the Registration Table 440 is first searched for an entry with an RCoA field 610 matching the given RCoA field in step 910. If no entry is found, step 950 will be taken where the next-hop destination is simply given as the RCoA of the mobile node.

If a matching entry is found, the algorithm enters the iteration of steps 920 and 930. In step 920, a temporary variable is set to contain the LCoA field 620 of the matching entry. Then in step 930, the Registration Table 440 is searched for an entry with a Prefix field 630 such that the address contained in the temporary variable falls into the prefix specified by the Prefix field 630. If one such entry is found, the algorithm re-iterates to step 920. If no such entry can be found, the iteration is exited and the algorithm returns with the next-hop destination given by the address stored in the temporary variable, and shown in step 940.

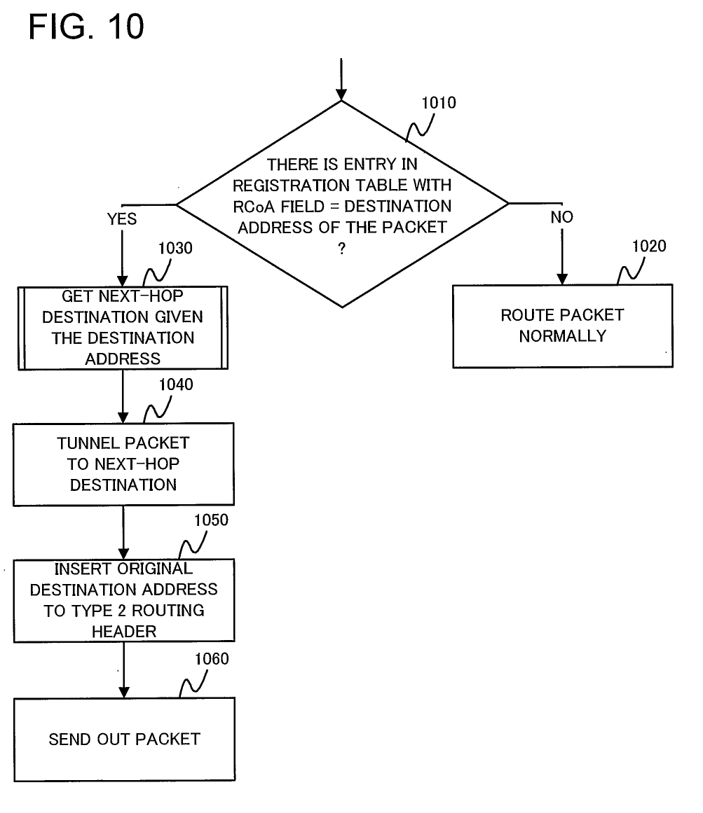

To complete the disclosure of MAP 120, the preferred algorithm used by MAP 120 when forwarding packets is next described. Of particular focus here is when the MAP is forwarding packets addressed to the RCoA of a registered mobile node to the LCoA of the mobile node. FIG. 10 depicts the algorithm used by Routing Unit 120 when forwarding such packets. First, in step 1010, the Registration Table 440 is searched for an entry with an RCoA field 610 that matches the destination address of the received packet. If no matching entry is found, the packet is routed normally, as shown in step 1020.

If a matching entry is found, the series of steps 1030 through 1060 will be taken which depicts the encapsulation of the received packet to be forwarded to the LCoA of the mobile node. In step 1030, the algorithm shown in FIG. 9 is used to obtain the next-hop destination given the RCoA of the mobile node (i.e. the destination address of the received packet). The received packet is then encapsulated in an outer packet, where the destination address of the outer packet is set to the next-hop destination obtained from step 1030, as shown in step 1040. In step 1050, a type 2 routing header containing the RCoA of the mobile node is inserted to the outer packet. This type 2 routing header serves to inform nodes forwarding this packet which node is the intended final recipient. Finally, the packet is sent out, as shown in step 1060.

With this, the functionality of MAP 120 is fully disclosed according to a preferred embodiment of the present invention. It should be obvious to a person skilled in the art that the description here is by no means complete. Instead, the present invention serves only to teach how the enhancement of a traditional mobility anchor point can be made to follow the present invention. All other operations not mentioned in this document should follow that of a traditional mobility anchor point described in a prior art.

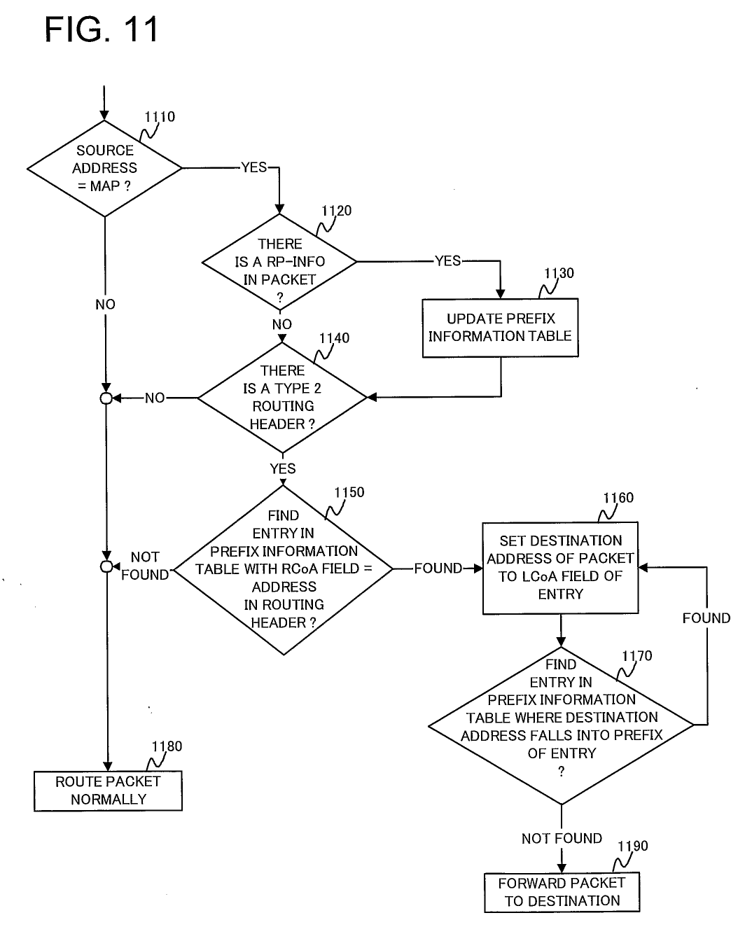

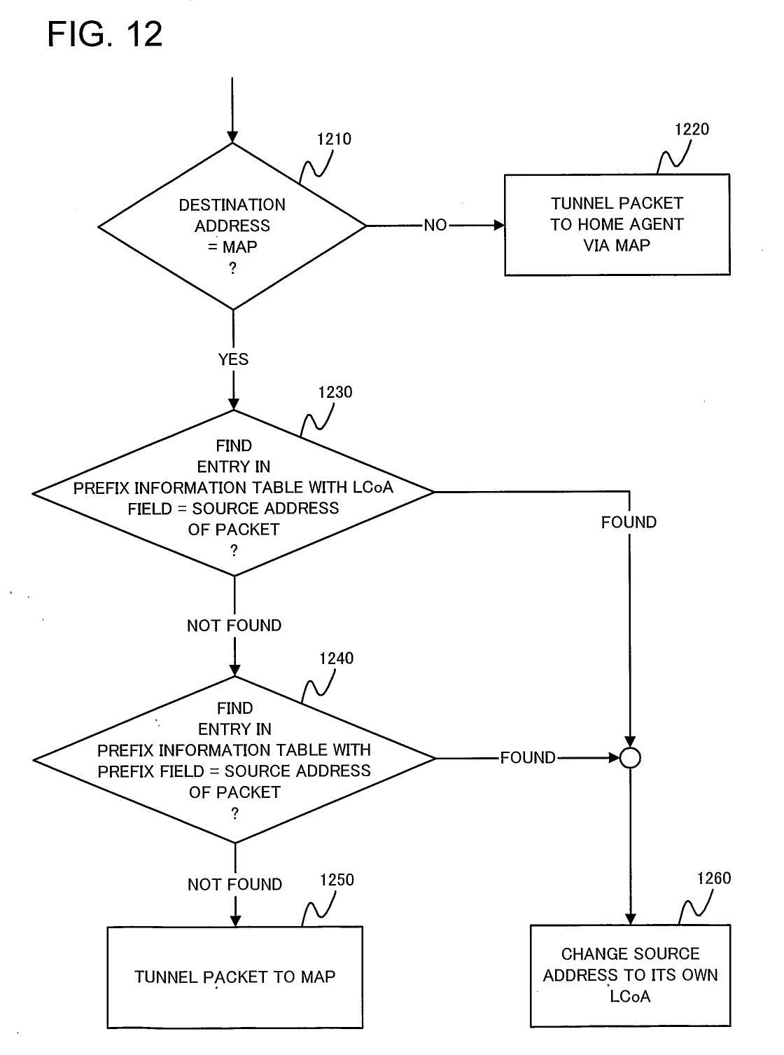

Having described the operations of MAP 120, we now turn our attention to the mobile routers MR 140, 142. FIG. 11 shows the processing steps of the mobile router when it receives a packet from an upstream network, and FIG. 12 shows the processing steps of the mobile router when it receives a packet from a downstream network.

By the term “upstream network”, we refer to the network where the mobile router attaches. For instance, referring to FIG. 1, the upstream network of MR 140 will be the access network 102, and the upstream network of MR 142 will be the mobile network 104. This is also known in the industries and by persons skilled in the art as the egress network.

Conversely, by the term “downstream network”, we refer to the network where the mobile router serves as a default router. For instance, referring to FIG. 1, the downstream network of MR 140 will be the mobile network 104, and the downstream network of MR 142 will be the mobile network 106. This is also known in the industries and by persons skilled in the art as the ingress network.

In FIG. 11, when the Routing Unit 520 of mobile router MR 140 or MR 142 receives a packet from the upstream network, it first checks if the source address of the received packet is the address of the MAP, as shown in step 1110. If the source address is not the address of the MAP, step 1180 is taken where the packet is routed as per specified by IPv6 or NEMO Basic Support.

On the other hand, if the packet is sent by the MAP, step 1120 will be taken. Here, the received packet is checked to see if a RP-Info option is present in the packet header. If there is one, the information stored in the RP-Info option is used to update the Prefix Information Table 550, as shown in step 1130.

After checking for the RP-Info option, the packet is next checked for the presence of a type 2 routing header in step 1140. If none is present, the packet is routed normally, as shown in step 1180. Else step 1150 is taken where the Prefix Information Table 550 is searched for a matching entry with the RCoA field 610 equal to the address stored in the type 2 routing header.

If no matching entry is found, the packet is routed normally, as shown by step 1180. If a matching entry is found, the iteration of steps 1160 and 1170 is followed through in order to change the destination address of the received packet to its next intermediate address.

In step 1160, the destination address of the received packet is first set to the LCoA field 620 of the matching entry found in the Prefix Information Table 550. Then in step 1170, the Prefix Information Table is searched again for a matching entry with a Prefix field 630 such that the current destination address of the received packet falls into the prefix specified by the Prefix field 630. If one such entry is found, the algorithm re-iterates to step 1160. If no such entry can be found, the iteration is exited and the packet is forwarded, and shown in step 1190.

In FIG. 12, when the Routing Unit 520 of mobile router MR 140 or MR 142 receives a packet from the downstream network, it first checks if the destination address of the received packet is the address of the MAP, as shown in step 1210. If the destination address is not the address of the MAP, step 1220 is taken where the packet is tunneled back to the home agent of the mobile router as required by NEMO Basic Support.

On the other hand, if the destination address is the address of the MAP, step 1230 is taken. Here, the Prefix Information Table 550 is searched for a matching entry with the LCoA field 620 equal to the source address of the received packet. If one such entry is found, the source address of the packet is changed to the LCoA of the mobile router, and the packet is forwarded upstream, as shown in step 1260. If no such entry is found, step 1240 is taken where the Prefix Information Table 550 is searched for a matching entry with a Prefix field 630 such that the source address of the received packet falls into the prefix specified by the Prefix field 630.

If one such entry is found, the source address of the packet is changed to the LCoA of the mobile router, and the packet is forwarded upstream, as shown in step 1260. If no such entry is found, the Routing Unit 520 cannot determine that it is safe to change the source address of the packet. Since the packet is addressed to the MAP, a tunnel to the home agent of the mobile router is not necessary. Instead, as shown in step 1250, the packet is encapsulated into a tunnel destined for the MAP.

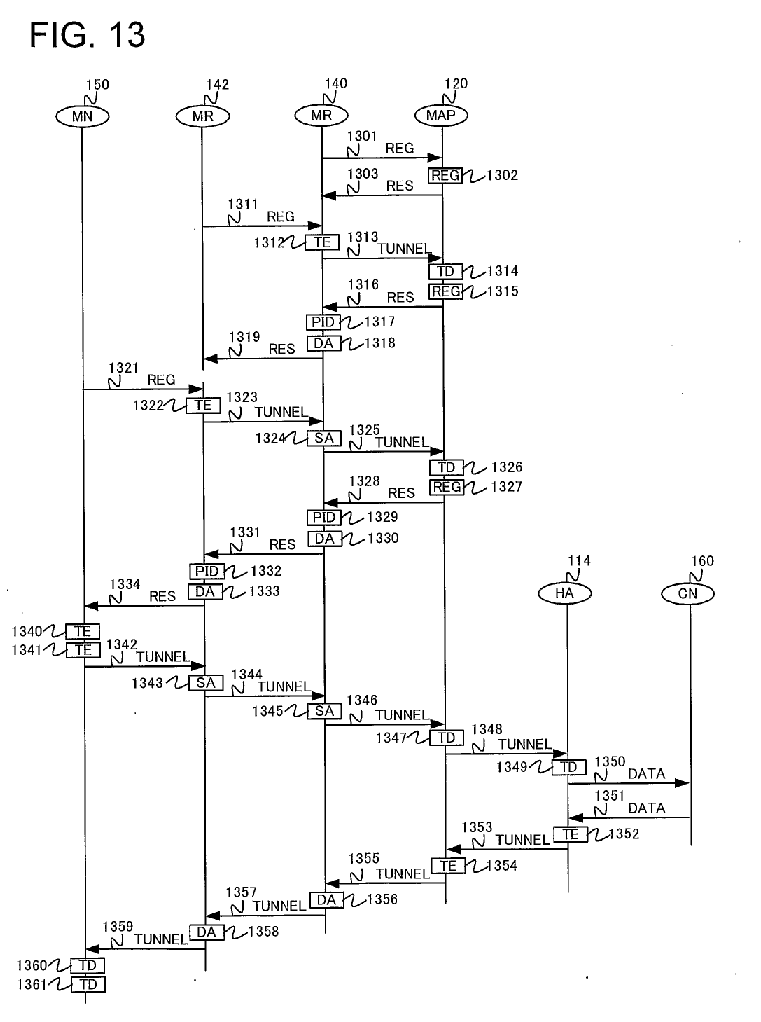

To illustrate how the RP-Info 720 works, FIG. 13 shows the message sequence diagram illustrating the messages sent between the mobile node MN 150, mobile routers MR 140, 142, and MAP 120 during registrations. Note that binding updates sent to home agents are omitted from FIG. 13. In FIG. 13, a registration message, a response message, a tunnel packet, tunnel encapsulation, tunnel decapsulation, a registration process, a RP-info process, a destination address change process, a source address change process are referred as REG, RES, TUNNEL, TE, TD, REG, PID, DA and SA, respectively.

The message sequences 1301 through 1303 show MR 140 registering with MAP 120. First, MR 140 sends a registration message 1301 to MAP 120. The source address of the registration message 1301 contains the LCoA of MR 140, and the home address option contains the RCoA of MR 140. MAP 120 updates the Registration Table 440 as shown in the registration (REG) process 1302. This includes adding the mapping of LCoA and RCoA of MR 140, and the prefix information of mobile network 104 to Registration Table 440. The readers are reminded that the prefix information may be the prefix owned by the mobile router MR 140, or a prefix delegated to MR 140 (possibly by MAP 120 itself). MAP 120 then replies with registration response 1303 to acknowledge the registration.

The message sequences 1311 through 1319 show MR 142 registering with MAP 120. First, MR 142 sends a registration message 1311 to MAP 120. The source address of the registration message 1311 contains the LCoA of MR 142, and the home address option contains the RCoA of MR 142. The registration message 1311 is intercepted by the mobile router 140. Since the destination address of this registration message 1311 is MAP 120, step 1230 of FIG. 12 will be taken. However, no entry can be found in the Prefix Information Table 550 that matches the source address of the registration message 1311. Thus, step 1250 will be taken where the packet 1311 will be encapsulated to MAP 120. This is shown in FIG. 13 as the tunnel encapsulation (TE) process 1312. This results in the tunnel packet 1313 with the source address equal to LCoA of MR 140, the destination address equal to the address of MAP 120, and the home address option containing the RCoA of MR 140.

MAP 120 then decapsulates the packet 1313, as shown by the tunnel decapsulation (TD) process 1314, and processes the registration message 1311. This is shown in FIG. 13 as process 1315 which includes adding the mapping of LCoA and RCoA of MR 142, and the prefix information of mobile network 106 to Registration Table 440. MAP 120 then replies with registration response 1316 to acknowledge the registration.

According to algorithm shown in FIG. 8, the destination address of the message 1316 will contain the LCoA of MR 140, the type 2 routing header will contain the RCoA of MR 142 and the packet header will be inserted with a RP-Info option. When MR 140 receives this packet 1316, it notices the RP-Info option. Thus, according to step 1130 of FIG. 11, MR 140 will insert the information stored in the RP-Info option to its Prefix Information Table 550, as shown by the process 1317. After which, according to steps 1140 through 1170 of FIG. 11, MR 140 would replace the destination address of the packet 1316 with LCoA of MR 142. This is shown by the destination address change (DA) process 1318, and resulted in the packet 1319 that is forwarded to MR 142. From the illustrations of processing taken by MR 140, one can appreciate the need for steps 1120 and 1130 of FIG. 11 where the RP-Info option is used to update the Prefix Information Table 550 to take place before the change of the destination address (steps 1140 through 1170).

The message sequences 1321 through 1334 show mobile node MN 150 registering with MAP 120. First, MN 150 sends a registration message 1321 to MAP 120. The source address of the registration message 1321 contains the LCoA of MN 150, and the home address option contains the RCoA of MN 150. The registration message 1321 is intercepted by mobile router MR 142. Since the destination address of the destination message 1321 is MAP 120, step 1230 of FIG. 12 will be taken. However, no entry can be found in the Prefix Information Table 550 that matches the source address of the registration message 1321. Thus, step 1250 will be taken where the packet 1321 will be encapsulated to MAP 120. This is shown in FIG. 13 as the tunnel encapsulation process 1322. This results in the tunnel packet 1323 with the source address equal to LCoA of MR 142, the destination address equal to the address of MAP 120, and the home address option containing the RCoA of MR 142.

When MR 140 receives this packet, a matching entry is found from step 1230 of FIG. 12. Thus, the source address of the packet is changed to the LCoA of MR 140 as shown by the source address change (SA) process 1324, resulting in the packet 1325. MAP 120 then decapsulates the packet (process 1326) and updates the Registration Table 440 based on the inner registration message (process 1327).

MAP 120 then replies with the registration response 1328 to acknowledge the registration. According to the algorithm shown in FIG. 8, the destination address of the message 1328 will contain the LCoA of MR 140, the type 2 routing header will contain the RCoA of MN 150 and the packet header will be inserted with a RP-Info option. When MR 140 receives this packet 1328, it notices the RP-Info option. Thus, according to step 1130 of FIG. 11, MR 140 will insert the information stored in the RP-Info option to its Prefix Information Table 550, as shown by the process 1329.

After which, according to steps 1140 through 1170 of FIG. 11, MR 140 would replace the destination address of the packet 1328 with LCoA of MR 142. This is shown by the process 1330, and resulted in the packet 1331 that is forwarded to MR 142. Again, MR 142 would notice the RP-Info option, and insert the information stored in the RP-Info option to its Prefix Information Table 550, as shown by the process 1332. After which, according to steps 1140 through 1170 of FIG. 11, MR 142 would replace the destination address of the packet 1331 with LCoA of MN 150. This is shown by the process 1333, and results in the packet 1334 that is forwarded to MN 150.

The above descriptions illustrate how the prefix information is disseminated with the registrations of each mobile node/router. Message sequences 1340 through 1361 illustrate how packets are passed between MN 150 and the correspondent node CN 160. When MN 150 wishes to send a packet to CN 160, it first encapsulates the packet to be forwarded to its home agent HA 114 as per Mobile IPv6 specification. This is shown in the process 1340. Since the tunnel packet sent to home agent HA 114 has RCoA of MN 150 as the source address, the packet is further encapsulated with process 1341 to be forwarded toward MAP 120. This result in the packet 1342 with the source address equal to LCoA of MN 150 and with the destination address equal to the address of MAP 120.

The packet 1342 is then intercepted by mobile router MR 142. Since the destination address of the packet 1342 is MAP 120, step 1230 of FIG. 12 will be taken. Now, an entry in the Prefix Table 440 of MR 142 can be found to contain the LCoA of MN 150. Thus, MR 142 will change the source address of packet 1342 to the LCoA of MR 142 as shown by process 1343. The resulting packet 1344 is then forwarded to MR 140.

When MR 140 receives this packet, a matching entry is found from step 1230 of FIG. 12. Thus, the source address of the packet is again changed to the LCoA of MR 140 as shown by the process 1345, resulting in the packet 1346. MAP 120 then decapsulates the packet (process 1347) and forwards the inner packet 1348 to the global internet 100. This packet 1348 is the first tunnel packet with the source address equal to RCoA of MN 150 and the destination address equal to the address HA 114. HA 114, upon receiving this packet, decapsulates it and extracts the inner data packet. This is shown in FIG. 13 as process 1349. The inner data packet 1350 is finally routed to CN 160.

When CN 160 sends a packet 1351 to MN 150, since the destination address is the home-address of MN 150, it will be routed to HA 114. HA 114 will encapsulates this packet 1350 to be forwarded to the RCoA of MN 150, as shown by the process 1352. The resulting packet 1353 is then routed to MAP 120. MAP 120 upon receiving this packet checks its Registration Table 440 and found an entry for the RCoA of MN 150. According to steps 1030 through 1060 of FIG. 10, MAP 120 will further encapsulate this packet with the destination address equal to LCoA of MR 140 and insert a type 2 routing header containing the RCoA of MN 150. This is shown in FIG. 13 as process 1354. The resulting packet 1355 is then forwarded to MR 140.

When MR 140 receives this packet 1355, according to steps 1140 through 1170 of FIG. 11, MR 140 would replace the destination address of the packet 1355 with LCoA of MR 142. This is shown by the process 1356, and resulted in the packet 1357 that is forwarded to MR 142. Again, MR 142 would use the algorithm shown in FIG. 11 and replaces the destination address of the packet 1357 with LCoA of MN 150. This is shown by the process 1358, and results in the packet 1359 that is forwarded to MN 150. MN 150 then performs two decapsulations to retrieve the original data packet 1351 sent by CN 160. The first decapsulation 1360 is to decapsulate the tunnel encapsulated by MAP 12.0. The second decapsulation 1361 is to decapsulate the tunnel encapsulated by HA 114.

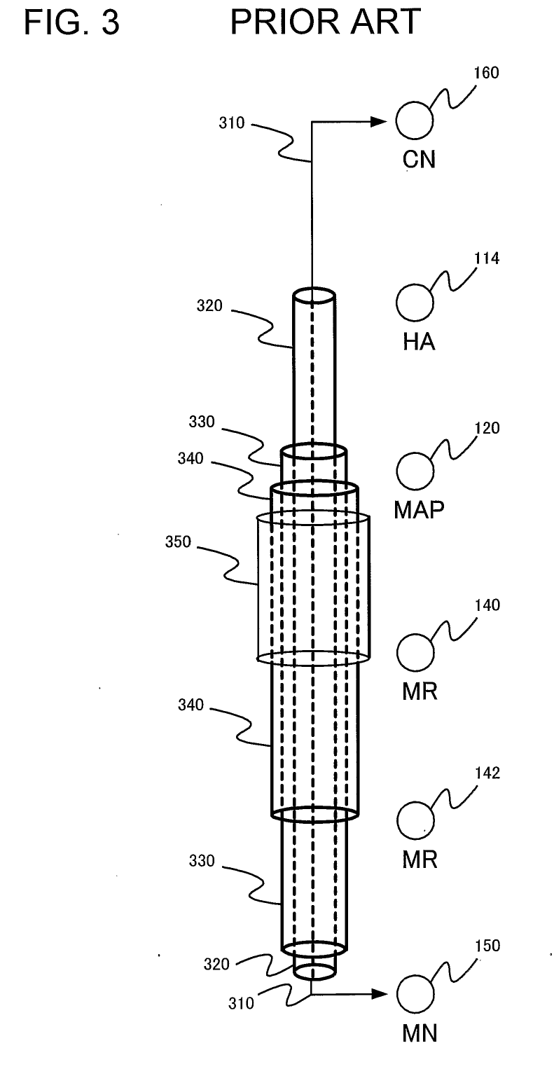

From the above illustrations, one can see that between MN 150 and MAP 120, there is only one additional tunnel, even though MN 150 is behind two mobile routers (MR 140 and 142). This is indeed an improvement compared to the three-tunnel encapsulations shown in FIG. 3. In fact, a person skilled in the art can easily extend the example shown in this document and show that regardless of the number of mobile routers the mobile node is attached to, there would only be one additional tunnel between the mobile node and a mobility anchor point. Hence the object of the present invention is clearly met.

In addition, a person skilled in the art may appreciate the present invention as achieving the same effect of as a routing header based solution such as the Reverse Routing Header described in Non-Patent Document 4. In fact, in the present invention, the intermediate mobile routers would change the source address of an ingress packet going upstream much the same way as though a reverse routing header is attached to the packet, and the intermediate mobile routers would change the destination address of an egress packet going downstream much the same way as though an extended type 2 routing header is attached to the packet. This is the greatest effect of the present invention in that it removes the need of using reverse and extended routing headers with dissemination of the prefix information. Since prefix information is disseminated less frequently than the transmission/reception of data packets, the present invention has better bandwidth utilization too.

Although the invention has been herein shown and described in what is conceived to be the most practical and preferred embodiment, it will be appreciated by those skilled in the art that various modifications may be made in details of design and parameters without departing from the scope and ambit of the invention. For example, in FIG. 1, the mobility anchor point 120 is depicted to be a stationary node in the access network 102. It is possible for one to employ the mobility anchor point functionality on a mobile router. A person skilled in the art would recognize that the present invention would operate mostly in the same manner when MAP 120 is also a mobile router.

In addition, it is also possible that the functionalities can be distributed. For instance, certain functionalities of the mobility anchor points can be distributed among multiple nodes, possibly in a hierarchical manner. As yet another example, the access router AR 130 in FIG. 1 may itself implement the mobility anchor point functionality partially or fully. In fact, it is possible for AR 130 to implement the mobile router functionality partially or fully as well. One can even assume an access router implementing partly or fully both the mobility anchor point and mobile router functionalities. It should be recognized by person skilled in art that departures such as those afore-illustrated are well within the scope of the invention.

Furthermore, the present invention is intentionally disclosed in such way so that the specifics of the prefix information of mobile networks are kept general. One preferred arrangement would be each mobile router has two prefixes announced to the mobile network it manages. One of two prefixes is delegated by the home network which is advertised normally so that ordinary mobile network nodes would configure their addresses from this prefix. This prefix does not normally change so that ordinary mobile network nodes need not reconfigure their addresses.

Another prefix may be delegated by the home network, or delegated by the access network (such as the MAP). This prefix is advertised in such a way that ordinary mobile network nodes would not configure their addresses from this prefix. Instead only mobile nodes that wish to make use of the services provided by the MAP would configure their LCoA from this prefix. In this way, it is possible for the mobile router to decide whether to change the source/destination addresses based on the addresses used. A person skilled in the art would appreciate that such modifications would still fall under the ambit and scope of the present invention.

### INDUSTRIAL APPLICABILITY

The present invention has the advantage of reducing the number of encapsulations required when MAP forwards a packet to a mobile node which is layered within mobile networks, with mobile networks nested and multiple mobile routers chained behind MAP. The present invention can be applied to the communication technology of the packet-switched data communication network or the packet forwarding and processing technology.

1. A method of controlling packet forwarding in a communication system, the communication system including a mobility anchor point which manages a hierarchical network, a mobile router which comprises a mobile network and a mobile node which is attached to the mobile network, the mobility anchor point storing address binding information on a binding between a local address for identifying location of a communication node within a network of the mobility anchor point and a global address used by the correspondent node to communicate with an outside of the network, the mobile node using an address configured based on a prefix advertised within the mobile network to communicate, wherein the mobile node is attached under the mobility anchor point's control, and wherein the mobility anchor point stores the address binding information on both the mobile router and the mobile node, the method comprising a step in which the mobility anchor point informs a mobile router on route to the mobile node about the address binding information of the mobile node and the prefix of the mobile network.

2. The method of controlling packet forwarding according to claim 1, comprising:
a prefix delegating step in which the mobility anchor point delegates a prefix to the mobile router, the delegated prefix being available for the prefix of the mobile network; and
a step in which the mobility anchor point informs a mobile router on route to the mobile router about the delegated prefix.

3. The method of controlling packet forwarding according to claim 1 comprising an address/prefix storing step in which the mobile router on route between the mobile node and the mobility anchor point stores the address binding information of the mobile node and the prefix of the mobile network if the mobile node or the mobile network resides at a lower level than the mobile router, the address binding information and the prefix being disseminated by the mobility anchor point.

4. The method of controlling packet forwarding according to claim 3, comprising:
a first packet forwarding step in which the mobility anchor point, when forwarding the packet to the mobile node, tunnels the packet to the local address of a mobile router which resides at a top level on route to the mobile node;
a second packet forwarding step in which the mobile router on route between the mobile node and the mobility anchor point, when receiving the packet, determines a next hop mobile router by referring to the address binding information of the mobile node and the prefix of the mobile network which the mobile router stores, changes a destination address of the packet to the local address of the determined mobile router and then forwards the packet.

5. The method of controlling packet forwarding according to claim 4 wherein, when the packet is forwarded, an address of the mobile node is placed in the packet in order to indicate that a final receiver of the packet is the mobile node.

6. The method of controlling packet forwarding according to claim 3, comprising:
a packet sending step in which the mobile node, when forwarding the packet toward the mobility anchor point, tunnels the packet to the local address of a mobile router which resides at a bottom level on route to the mobility anchor point; and
a packet forwarding step in which the mobile router on route between the mobile node and the mobility anchor point, when receiving the packet, determines a next hop mobile router by referring to the address binding information of the mobile node and the prefix of the mobile network which the mobile router stores, changes a destination address of the packet to the local address of the determined mobile router and then forwards the packet.

7. An apparatus for controlling packet forwarding arranged in a mobility anchor point which manages a hierarchical network, comprising:
a registration table storing means for storing address binding information on a binding between a local address for identifying location of a communication node within a network of the mobility anchor point and a global address used by the correspondent node to communicate with an outside of the network;
a prefix storing means for storing a prefix of a mobile network behind a mobile router whose address binding information is registered at the registration table storing means; and
an address informing means for informing a mobile router on route to the mobile node about the address binding information registered in the registration table storing means and the prefix of the mobile network.

8. An apparatus for controlling packet forwarding arranged in a mobile router which comprises a mobile network, comprising:
an address/prefix receiving means for, from a mobility anchor point which manages address binding information on a binding between a local address for identifying location of a communication node within a network of the mobility anchor point and a global address used by the correspondent node to communicate with an outside of the network, receiving the address binding information of the mobile node which resides at a lower level than itself and the prefix of the mobile network of the mobile router which resides at a lower level than itself; and
an address/prefix storing means for storing the address binding information and the prefix received by the address/prefix receiving means.
